(19) United States
(12) Patent Application Publication
(10) Pub. No.: US 2010/0015283 A1
(43) Pub. Date: Jan. 21, 2010

(54) Method of Preparing Powder Kimchi and Kimchi Composition Using the Same

(76) Inventors: Yong-hyun Jung, Gyeonggi-do (KR); Moon-kyung Choi, Gyeonggi-do (KR)

Correspondence Address: INTELLECTUAL PROPERTY LAW GROUP LLP, 12 SOUTH FIRST STREET, SUITE 1205, SAN JOSE, CA, 95113, US

(21) Appl. No.: 12/306,522

(22) PCT Filed: Jun. 26, 2007
(86) PCT No.: PCT/KR07/03090

§ 371 Date: Dec. 23, 2008

(30) Foreign Application Priority Data
Jun. 26, 2006 (KR) 10-2006-0057379

(51) Int. Cl. A23B 7/10

(52) U.S. Cl. 426/49; 426/61; 426/62

(57) ABSTRACT

Disclosed herein are a method for preparing kimchi powder and a kimchi composition containing said kimchi powder. The preparation method comprises the steps of: adding one or more selected from the group consisting of skimmed milk powder, skimmed milk, starch, dextrin, soybean milk, cheese and glycerol, to crushed or chopped kimchi produced by grinding or crushing kimchi, before or after a fermentation process; and freeze-drying the mixture so as to powder it.

### TECHNICAL FIELD

The present invention relates to a method for preparing kimchi powder containing kimchi as a main component and to a kimchi composition containing said kimchi powder, and more particularly to a method for preparing kimchi powder, which comprises adding a freezing stabilizer to crushed kimchi, containing kimchi and kimchi lactic acid bacteria, and freeze-drying the mixture to form powder having a uniform particle size, so as to make it possible to easily ingest nutrients contained in kimchi, their metabolites, and kimchi lactic acid bacteria, as well as a kimchi composition containing the kimchi powder.

### BACKGROUND ART

Kimchi is a Korean traditional food made of salted vegetables and spices, and the various effects and functions of kimchi have been known for a long time. For example, kimchi is known to have many important functions, including biological regulatory functions such as the promotion of digestion and the enhancement of immunogenicity, the prevention of diseases through antibacterial activity, anti-inflammatory activity, anti-mutagenic activity, anticancer activity and the like, wound healing enhancement, blood cholesterol reduction, biorhythm regulation, aging inhibition, diet effects and the like. These complex functions of kimchi are known to be based on kimchi lactic acid bacteria.

Meanwhile, kimchi has become an internationally well-known food. In the case of Japan, Japanese style kimchi, having a unique taste was developed by adding, to tsukemono, lactic acid bacteria associated with the characteristic taste of kimchi. In the case of the USA, there is a report that a kimchi museum is under construction with the support of the government. Recently, kimchi has received great attention in Korea and foreign countries due to the outbreak of severe acute respiratory syndrome (SARS) and avian influenza, while the export of kimchi to various countries, including Japan, China, Taiwan, Hong Kong and Singapore, has increased.

Although there have been many researches showing that the beneficial bacteria produced in a kimchi fermentation process have the effect of eliminating harmful microorganisms and that lactic acid bacteria also has the effect of inhibiting coronavirus infection, scientific studies on kimchi lactic bacteria are still considered insufficient. In the case of foreign countries, large-scale investments have been made in studies on microorganisms for use in traditional fermented foods such as yogurt and cheese, and particularly, the genome of Lactococcus lactis was identified by French researchers. In view of these facts, systematic and scientific studies on kimchi lactic acid bacteria contained in Korean traditional kimchi are also needed.

Up to now, among the microorganisms present on the earth, only a small minority of the microorganisms are known, and there is no information on the remaining microorganisms. It is thought that useful products such as antibacterial peptides should be developed from a variety of unknown microorganisms, including kimchi lactic acid bacteria, and as mankind has done to date, microorganisms should be used to provide bases for the improvement of human health, including the solution of problems of antibiotic toxicity and tolerance, the solution of a problem of food poisoning, the development of natural preservatives, the development of methods for the natural treatment of infectious diseases, and the like.

Meanwhile, kimchi is a fermented food having a shelf life shorter than that of other health functional foods, and can be recognized as a food that is difficult for foreigners, unfamiliar with kimchi, to eat due to its very strong taste and flavor. Also, for persons who avoid kimchi ingestion due to their westernized eating habits, the development of alternative foods, such as kimchi powder, kimchi powder capsules, kimchi powder granules and kimchi powder tablets, is required. Also, kimchi contains lactic acid bacteria, which are killed by gastric acid and bile acid in the stomach and intestines after ingestion. Moreover, the storage of living lactic acid bacteria is important for the human intake thereof, and lactic acid bacteria generate acids and gases in organisms containing moisture, because they are organisms. Therefore, kimchi, stored in the liquid state, has a short shelf life, and thus, if kimchi could be stored in a dried state, it would have a long shelf life.

Regarding storage methods, a drying process is very important for the stability of lactic acid bacteria. Drying at low-temperature air incurs low costs, but reduces the activity of lactic acid bacteria, because hot air kills a large number of lactic acid bacteria. For this reason, in industrial fields or laboratories, lactic acid bacteria are stored using a vacuum freezing drying method.

However, when lactic acid bacteria-fermented products are subjected to a freezing process, as many beneficial lactic acid bacteria as possible should survive in order to ensure the activity thereof, and for this purpose, a problem of lactic acid bacterial cell disruption caused by freezing should be solved in advance. That is, it is ensured that the useful components of kimchi are absorbed into the human body through ingestion, and that kimchi lactic acid bacteria survive in gastric acid and bile acid so as to maximize the function thereof in the small and large intestines.

Because lactic acid bacteria are used in the industrial fields, which employ fermented products, the viability thereof during their shelf life is very important. In order for lactic acid bacteria to be ingested orally, they should be able to resist a strongly acidic gastrointestinal environment (a pH below 4) and a bile acid environment, should be active in the intestines, and should grow and proliferate after intestinal colonization, such that sufficient function thereof is shown. In industrial fields, problems of the activity of some marketed lactic acid bacteria during their shelf life have arised, and in the functional food industry, efforts to solve the problems have been made.

In view of this point, there is an urgent need for a method that can be used to effectively freeze-dry kimchi to minimize the destruction of kimchi lactic acid bacteria, so as to make it possible to more effectively ingest kimchi components, their metabolites, and kimchi lactic acid bacteria.

### DISCLOSURE OF INVENTION

### Technical Problem

The present invention has been made in view of the above-described problems arising in the prior art, and it is an object of the present invention to provide a method for preparing kimchi powder, which makes it possible to easily ingest nutrients contained in kimchi, their metabolites, and kimchi lactic bacteria, as well as a kimchi composition containing said kimchi powder.

Another object of the present invention is to provide a method for preparing kimchi powder, which can ensure freeze-drying stability by adding a freezing stabilizer to kimchi and prevent the destruction of kimchi lactic acid bacteria to ensure the maximum number of lactic acid bacteria, as well as a kimchi composition containing said kimchi powder.

Still another object of the present invention is to provide a method for preparing kimchi powder, which can achieve the effect of masking the original taste and flavor of kimchi by coating lactic acid bacteria, enables persons of various ages and nationalities to ingest kimchi without difficulty, can ensure an enough shelf life of kimchi lactic acid bacteria, allows kimchi lactic acid bacteria to resist gastric acid and bile acid after ingestion, can induce the growth and proliferation of lactic acid bacteria in the intestines, and can provide the effects of the intestinal colonization and in vivo usefulness of lactic acid bacteria, as well as a kimchi composition containing said kimchi powder.

### Technical Solution

To achieve the above objects, according to one aspect of the present invention, there is provided a method for preparing kimchi powder, comprising the steps of: adding one or more selected from the group consisting of skimmed milk powder, skimmed milk, starch, dextrin, soybean milk, cheese and glycerol, to crushed or chopped kimchi, produced by grinding or crushing kimchi, before or after a fermentation process; and freeze-drying the mixture so as to powder it.

According to another aspect of the present invention, there is provided a method for preparing kimchi powder, comprising the steps of: adding one or more, selected from the group consisting of skimmed milk powder, skimmed milk, starch, dextrin, soybean milk, cheese and glycerol, to ground or crushed kimchi produced by grinding or crushing kimchi, before or after a fermentation process; adding, to the mixture, either sterilized and fermented kimchi or an isolated and identified lactic acid bacteria strain as a fermentation starter, followed by fermentation; and freeze-drying the fermented product so as to powder it.

According to still another aspect of the present invention, there is provided a method for preparing kimchi powder, comprising the steps of: adding one or more selected from the group consisting of NaHCO₃, KHCO₃, CaCO₃, sodium glutamate, gelatin, glycerol, adonitol, sugar alcohol, a milk product or a processed milk product, dextrin, starch, and cereal flour, to a mixture of a product, obtained through lactic acid bacteria fermentation of one or more selected from among carbohydrate-containing foods, with one or more selected from crushed kimchi, functional kimchi, kimchi and fermented kimchi; fermenting the mixture with lactic acid bacteria, if necessary; and subjecting the mixture to a freeze-drying process and a low-temperature drying process at 0-60° C. so as to powder it.

Herein, the carbohydrate-containing food is preferably any one selected from among crushed edible plants or extracts thereof, crushed cereals or extracts thereof, crushed vegetables or extracts thereof, crushed seaweed or extracts thereof, crushed fruit, crushed vegetables, soybeans or processed soybean products, sweet potatoes or processed sweet potato products, potatoes or processed potato products, yams or processed yam products, chlorophyll-containing foods, processed embryos, chlorella, spirulina, yeast, enzymes, red pepper paste (gochujang), fermented soybean paste (chungkukjang), soybean paste (doenjang), pickles, mushrooms, dietary fiber, carbohydrates, guar gum, gellan gum, milk-containing casein proteins, milk proteins, ginseng, teas and fermented vegetables.

Also, the milk product or the processed milk product is preferably any one selected from among milk, a processed milk product derived from milk, lactose, milk protein, an artificial milk powder composition, an artificial milk composition, a milk product composition, a milk product derived from livestock, cheese, skimmed milk, skimmed milk powder, whole milk powder, condensed milk and soybean milk.

Furthermore, the cereal flour is preferably any one selected from among rice flour, wheat flour, buckwheat flour, barley flour, Indian millet flour, Italian millet flour, millet flour, and maize flour.

According to yet another aspect of the present invention, there is provided a kimchi powder composition, comprising: kimchi powder prepared according to any one of said preparation methods, and soybean paste powder and lactic acid bacteria powder, the composition containing 1×10³ to 1×10¹¹ CFU/g of lactic acid bacteria.

Herein, the soybean paste powder may be any one selected from among Gochujang powder, soybean paste powder, Chinese bean paste (chunjang) powder, vinegar red pepper paste (chogochujang) powder, Chungkukjang powder, ssamjang (soybean paste/Gochujang mixture) powder, makjang (fermented soybeans, fried soybean powder, salt, and redhot pepper powder) powder, and jipjang (bean paste made from dried soybean malt, red pepper powder, glutinous rice, and dried slices of radish or cucumber) powder, and mixtures thereof.

Also, the kimchi composition may have a particle size of 10-180 mesh.

According to still another aspect of the present invention, there is provided a method for preparing kimchi powder, comprising the steps of: adding one or more selected from the group consisting of NaHCO₃, KHCO₃, CaCO₃, sodium glutamate, gelatin, glycerol, adonitol, sugar alcohol, a milk product or a processed milk product, dextrin, starch and cereal flour, to ground or crushed kimchi, produced by grinding or crushing non-fermented or fermented kimchi; fermenting the mixture, if necessary, and adding and mixing with the mixture one or more selected from the group consisting of gellan gum, casein protein and sea tangle powder; and freeze-drying the mixture.

Herein, the milk product or the processed milk product may be any one selected from among milk, a processed milk product derived from milk, lactose, milk protein, an artificial milk powder composition, an artificial milk composition, a milk product composition, a milk product derived from livestock, cheese, skimmed milk, skimmed milk powder, whole milk powder, condensed milk and soybean milk.

Also, the cereal powder may be any one selected from among rice flour, wheat flour, buckwheat flour, barley flour, Indian millet flour, Italian millet flour, millet flour, and maize flour.

According to still a further aspect of the present invention, there is provided a method for preparing kimchi powder, comprising the steps of: crushing 55-96.5 wt % of fermented kimchi to produce crushed kimchi; adding, to the crushed kimchi, 0.5-5 wt % of dextrin and 1-10 wt % of milk powder; maintaining the mixture at 5-40° C. for 3-24 hours to ferment it; adding, to the fermented product, 0.5-5 wt % of dextrin, 1-35 wt % of milk powder, 0.05-3 wt % of gellan gum, 0.1-7 wt % of sodium caseinate and 0.1-5 wt % of sea tangle powder, and stirring the mixture so as to coat the fermented product with the additives; and freezing the coated fermented product at −20° C. to −60° C., followed by drying it at 5-40° C. for 1-5 days.

Herein, the preparation method may further comprise: after the step of adding 0.5-5 wt % of dextrin and 1-10 wt % of milk powder to the crushed kimchi, a step of sterilizing the mixture at 60-130° C. for 10-60 minutes at a pressure of 0.1-5 kg/cm² or sterilizing the mixture with a radiation dose of 0.5-5 kGy; and adding isolated and identified lactic acid bacteria to the sterilized mixture.

According to yet a further aspect of the present invention, there is provided a kimchi powder composition, comprising: either kimchi powder prepared according to any one of said methods, or a kimchi composition containing said kimchi powder; and living lactic acid bacteria-containing powder, the kimchi powder composition containing more than 1×10⁵ CFU/g of lactic acid bacteria.

Herein, the content of the kimchi powder or kimchi composition in the kimchi powder composition may be 50-99.99 wt %, and the content of the living lactic acid bacteria-containing powder in the kimchi powder composition may be 0.01-50 wt %.

Also, the kimchi powder composition preferably has a particle size of 10-180 mesh.

### ADVANTAGEOUS EFFECTS

According to the present invention, there is provided a method for preparing kimchi powder, which makes it possible to easily ingest nutrients contained in kimchi, their metabolites, and kimchi lactic acid bacteria, as well as a kimchi composition containing said kimchi powder.

Also, according to the present invention, there is provided a method for preparing kimchi powder, which can ensure freeze-drying stability by adding a freezing stabilizer to kimchi and to prevent the destruction of kimchi lactic acid bacteria to ensure the maximum quantity of lactic acid bacteria, as well as a kimchi composition containing said kimchi powder.

Furthermore, according to the present invention, there is provided a method for preparing kimchi powder, which can achieve the effect of masking the original taste and flavor of kimchi by forming coating layers around lactic acid bacteria, enables persons of various ages and nationalities to ingest kimchi without difficulty, can ensure the shelf life of kimchi lactic acid bacteria for an extended period of time, allows kimchi lactic acid bacteria to resist gastric acid and bile acid after ingestion, can induce the growth and proliferation of lactic acid bacteria in the intestines, and can provide effects attributable to the intestinal colonization and in vivo usefulness of lactic acid bacteria, as well as a kimchi composition containing said kimchi powder.

### BEST MODE FOR CARRYING OUT THE INVENTION

In Korea, dozens of different kinds of kimchi, including Chinese cabbage kimchi, whole cabbage kimchi, cabbage kimchi, cubed radish kimchi, watery radish kimchi and mustard kimchi, are known. Although these kimchi products contain slightly different basic ingredients, they are common in that they contain simillar sub-ingredients. In the present invention, all such kinds of kimchi may be used as raw materials. The present invention can be applied to all such kinds of kimchi, and hereinafter, a method of preparing kimchi powder according to the present invention using such kimchi, and a method for producing a kimchi composition using the same, will be described in further detail using Chinese cabbage kimchi as a typical example.

(A) Selection of Raw Materials and Pretreatment of Kimchi Raw Material

Good quality Chinese cabbage, garlic, Welsh onion, ginger and the like are selected, weighed, and mixed with each other at conventional mixing ratios. For example, 75-85% wt % of Chinese cabbage, 10-20 wt % of radish, 2-5 wt % of Welsh onion, 0.5-2 wt % of ginger, 1-2 wt % of garlic, 0-0.3 wt % of red pepper powder, 0.2-0.5 wt % of salt, 1-2 wt % of sugar, 1-2 wt % of salted anchovy sauce, 1-2 wt % of salted shrimp, 1-2 wt % of wheat flour paste and 0.2-1 wt % of fermented kimchi may be mixed with each other.

Said materials are sufficiently washed with running water, and then placed on a sieve to remove water. This washing process is carried out in order to remove foreign matter, soil, bacteria and the like. The salted anchovy sauce and the salted shrimp are sterilized before use, in order to prevent the invasion of various bacteria, which can exist in the intestines and on the skin of the fish, to facilitate the fermentation of lactic acid bacteria during kimchi fermentation.

Chinese cabbage is divided into two equal parts, and refined salt is added to the divided cabbage parts, such that it reaches the inner portion of the cabbage parts. Then, the Chinese cabbage parts are left to stand for 6 hours to salt them to ensure the death of general bacteria by osmotic pressure and the washing process. Then, the salted cabbage parts are washed and rinsed four times with running water and placed on a sieve to drain the water.

(B) Crushing of Materials

The kimchi raw materials, which consist of 75-85% wt % of the Chinese cabbage, pretreated as described above, 10-20 wt % of radish, 2-5 wt % of Welsh onion, 0.5-2 wt % of ginger, 1-2 wt % of garlic, 0-0.3 wt % of red pepper powder, 0.2-0.5 wt % of salt, 1-2 wt % of sugar, 1-2 wt % of salted anchovy sauce, 1-2 wt % of salted shrimp, etc., are crushed by passing them through a chopper having attached thereto a plate having 2-5 mm holes. The crushing process serves to increase the fermentation rate of kimchi lactic acid bacteria, mix the nutrients of the kimchi raw materials uniformly, form a uniform nutrient medium state that helps the growth of lactic acid bacteria, facilitate the fermentation of lactic acid bacteria and make it easy to carry out a coating process after a fermentation process.

(C) Mixing of Raw Materials

Crushed Chinese cabbage and radish, garlic, Welsh onion, ginger, sterilized salted anchovy sauce, salted shrimp, 1-2 wt % of sterilized salted anchovy sauce, 0.2-0.5 wt % of salt, 1-2 wt % of sugar, 0-0.3 wt % of red pepper powder, 1-2 wt % of wheat flour paste and the like are mixed with each other at said mixing ratio according to a conventional method.

Meanwhile, for the growth promotion and stability of lactic acid bacteria, one or more selected from NaHCO₃, KHCO₃, CaCO₃, sodium glutamate, gelatin, glycerol, adonitol, sugar alcohol, cheese powder, milk, a processed milk product derived from milk, lactose, milk protein, an artificial milk powder composition, an artificial milk composition, a milk product composition, a milk product derived from livestock, dextrin, starch, rice flour, wheat flour, maize flour, cereal flour, milk powder, soybean milk, and mixtures of two or more thereof, may be added to one selected from lactic acid bacteria fermented one obtained by fermenting one or more selected from crushed edible plants or extracts, crushed cereals or extracts, crushed fruit vegetables or extracts, crushed seaweed or extracts, crushed fruit, crushed vegetables, soybeans or processed soybean products, sweet potatoes or processed sweet potato products, potatoes or processed potato products, yams or processed yam products, chlorophyll-containing foods, processed embryos, chlorella, spirulina, yeast, enzymes, red pepper paste (gochujang), fermented soybeans (chungkukjang), soybean paste (doenjang), pickles, mushrooms, dietary fibers, carbohydrates, guar gum, gellan gum, milk-containing casein proteins, milk proteins, ginseng, teas, and fermented vegetables; crushed kimchi raw materials; kimchi and fermented kimchi.

Red pepper powder may be added in an amount less than a conventional amount to eliminate the hot taste and flavor, and when red pepper is not added, white kimchi (baek kimchi) can be prepared. After all of the raw materials are finally mixed with each other, the mixture may be radio-sterilized or heat-sterilized, such that no harmful microorganisms are present in fermented kimchi.

(D) Fermentation and Filtration of Kimchi

All of the raw materials are placed in a sterilized fermentation tank and mixed by stirring. Then, a selected kimchi lactic acid bacteria strain (1×10⁶ 5×10⁶ CFU of lactic acid bacteria per g of Chinese cabbage) or 0.2-1 wt % of previously fermented kimchi (1×10⁶5×10⁶ CFU of kimchi lactic acid bacteria per g of Chinese cabbage) is added thereto and mixed with stirring. The mixture is fermented at 16-25° C. for 3 days, and then passed through a filter equipped with a 30-20 mesh screen. After the fermentation process, if necessary, a red pigment, hot taste, acid components and salt components may be removed from the fermented product, or the fermented product may be passed through ion exchange resin or a special filtration system to take only useful components and lactic acid bacteria, or the fermented product may be concentrated to take only lactic acid bacteria, before a subsequent process is carried out.

(E) Addition of Freezing Stabilizer

In order to impart freezing stability to said ground or crushed kimchi, one or more selected from the following materials are added to the said ground or crushed kimchi before or after the fermentation process: skimmed milk powder, skimmed milk, starch, dextrin, glycerol, NaHCO₃, KHCO₃, CaCO₃, sodium glutamate, gelatin, adonitol, sugar alcohol, milk, a processed milk produce (such as cheese) derived from milk, lactose, milk protein, an artificial milk composition, an artificial milk product composition, a milk product composition, a milk product derived from livestock, rice flour, wheat flour, maize flour, cereal flour, cheese, whole milk powder, condensed milk and soybean milk.

(F) Vacuum Freeze-Drying

The fermented kimchi having the freezing stabilizer added thereto is rapidly frozen at a temperature of −40° C. to −50° C., and dried at 15-40° C. in a vacuum of 0.01-4.58 mmHg, thus achieving the vacuum freeze-drying of the fermented kimchi. This vacuum freeze-drying step may be carried out before or after first to third coating steps or after each of the coating steps.

(G) Coating

1) First-Step Coating

A 0.1-1.3 wt % solution of guar gum: gellan gum (1:1 W/W) is added to the fermented kimchi in an amount of 0.1-35 wt % based on the fermented kimchi and mixed with stirring to coat the fermented kimchi with the gum solution. Guar gum, a rubbery material obtained from the seed of the guar plant, consists of galactomannan, which is readily hydrated and forms a highly viscous solution even in cold water. It has the highest viscosity among natural rubbery materials, and forms gel in a 2-3% solution. Thus, it is additionally helpful in preventing the disruption of lactic acid bacteria cells in the freeze-drying process. After the inventive product comprising lactic acid bacteria coated with guar gum is ingested, it can be moved into the small intestine without being digested by bile acid or a protein digestive enzyme, because the guar gum is a non-digestive polysaccharide. Also, because the guar gum is mixed with the constituent components of kimchi, it cannot be digested in the small intestine by glycosidase, but can be degraded in the small intestine, making the growth of kimchi lactic acid bacteria possible. Gellan gum, a fermentation metabolite, shows strong gel strength even in a low-concentration aqueous solution, and thus is highly stable down to an acidity of pH 3.5. For this reason, the kimchi lactic acid bacteria coated with guar gum and gellan gum are protected from gastric acid.

2) First-Step Screening

If necessary, the vacuum freeze-dried material is passed through an oscillator or sieve equipped with a 20-40 mesh screen, thus making the particle size uniform.

3) Second-Step Coating

A 0.1-1.3 wt % solution of casein protein is added to the dried particles in an amount of 0.1-28 wt % based on the weight of the particles, and the mixture is stirred at high speed to coat the particles with the casein protein, followed by vacuum freeze-drying, as described above. Alternatively, the particles are coated with the casein protein solution by injecting and drying the casein protein solution using a fluidized bed granulator (inlet temperature: 50° C., outlet temperature: 40° C., injection rate: 11 ml/min, and rotor: 300 RPM).

78-80% of milk protein consists of casein protein. However, the casein protein precipitates at a pH of 5.2-5.3 to form curd clot. This is supported by the fact that milk fermented by lactic acid bacteria curdles at an isoelectric pH. Similarly, the curdled milk regurgitated by a baby after suckling milk is caused by the fact that casein has been converted to paracasein by gastric acid. With respect to this phenomenon, when the kimchi lactic acid bacteria coated with the casein protein according to the present invention is ingested and brought into contact with gastric acid, the casein protein is converted to an insoluble paracasein protein so as to able to prevent active lactic acid bacteria from coming into contact with gastric acid.

4) Third-Step Coating

A 0.1-5 wt % solution of sea tangle powder is used to form a third coating layer on the outer surface of the casein protein-coated powder. For this purpose, the sea tangle solution is added to the double-coated powder in an amount of 0.1-28 wt % based on the weight of the powder, and the mixture is stirred at high speed to coat the powder with the sea tangle solution, followed by vacuum freeze-drying as described above. Alternatively, the powder is coated with the sea tangle solution by injecting and drying the sea tangle solution using a fluidized bed granulator (inlet temperature: 50° C., outlet temperature: 40° C., injection rate: 11 ml/min, and rotor: 300 RPM), such that the resulting coated product has a water content of 2-3%.

Sea tangle powder, a natural edible material, is a food material which has been used for a long time as food, and it contains 7% proteins, 1.5% fats, 49% carbohydrates and 26.5% inorganic substances. 5-10% of the carbohydrates are celluloses, and the remaining parts are polysaccharides, such as alginate-based laminarin and fucoidin. Such substances are hardly digested and are almost not used as calorie sources, but are rich in inorganic substances, such as iodine, potassium and calcium. Thus, because the sea tangle solution contains polysaccharides such as alginate and fucoidin, it has a characteristic in that it gels at a pH lower than 5, such as in gastric acid. For this reason, the kimchi lactic acid bacteria surrounded by the sea tangle solution are prevented from coming into contact with gastric acid, such that the growth and proliferation activity of the lactic acid bacteria is not lost. The sea tangle layer surrounding the coated lactic acid bacteria is degraded in the upper portion of the small intestine and the large intestine, which has an alkalinity of pH 7.0-8.8, and the lactic acid bacteria colonize, grow and proliferate in the intestines, and thus exhibit various effects, such as intestinal regulation and immunity enhancement. Meanwhile, instead of the sea tangle solution, a solution of brown seaweed, such as Hizikia fusiforme, Undaria pinnatifida or Ecklonia cava, can be used as the coating solution.

Meanwhile, because the sea tangle solution surrounding the kimchi lactic acid solution under an alkaline condition comprises a plurality of proteins and polysaccharides, the gelled structure thereof is slowly degraded by pancreatin, protease and glycosidase secreted from the small intestine under a weak alkaline condition. Thus, the kimchi lactic acid bacteria, which have been present in the coating layer, grow in the intestines, and the nutrients and physiologically active ingredients of kimchi are digested and absorbed in the intestines, thus promoting human health.

5)Second-Step Screening

If necessary, the triple-coated kimchi lactic acid bacteria particles are placed in a sieve or oscillator having a 100-20 mesh screen and are passed through the screen while being stirred to make the particle size uniform, thus completing the kimchi powder of the present invention.

Hereinafter, the present invention will be described in further detail with reference to examples. However, various modifications, additions and substitutions with respect to these examples are possible, without departing from the scope and spirit of the invention. Therefore, it is to be understood that the preferred embodiments and examples described herein are for illustrative purposes only and are not to be construed to limit the scope of the present invention.

### Example 1 and Comparative Example

The following ingredients for preparing kimchi were weighed to provide unmixed ingredients in a conventional mixing ratio as follows: as the main ingredient of kimchi, 75 wt % of Chinese cabbage, which was salted with coarse salt for 6 hours and washed four times, and as sub-ingredients, 13.9 wt % of radish, 1.5 wt % of garlic, 2 wt % of Welsh onion, 1 wt % of ginger, 1 wt % of sterilized salted anchovy sauce, 1 wt % of sterilized salted shrimp, 0.3 wt % of salt, 2 wt % of sugar, 0.3 wt % of red pepper powder, and 2 wt % of wheat flour paste. The Chinese cabbage, the radish, the garlic, the Welsh onion, the ginger and the salted shrimp are passed through a chopper having attached thereto a plate having 5 mm holes, to crush them. Then, the remaining sub-materials were added thereto, thus preparing crushed kimchi.

Also, a portion of the crushed kimchi was sterilized in a high-temperature and high-pressure sterilizer at a temperature of 121° C. and a pressure of 1.2 atm, or was sterilized at a radiation dose of 0.5-5 kGy, and commercially available lactic acid bacteria powder was added to the sterilized crushed kimchi as a fermentation medium. Then, the mixture was fermented three times at 16° C. to produce about 5×10⁶ CFU/g of kimchi lactic acid bacteria in the crushed kimchi. The fermented crushed kimchi was used as a kimihi fermentation starter.

The kimchi fermentation starter was added to the crushed kimchi, and the mixture was stirred for 20 minutes and fermented in a fermenter at 16° C. for 7 days. Then, each of dextrin and starch, as freezing stabilizers, was added to the fermented kimchi in an amount of 4 wt % based on the weight of the fermented kimchi, and a 0.4 wt % solution of guar gum: gellan gum (1:1 w/w) was added to the fermented kimchi in an amount of 0.2 wt % based on the weight of fermented kimchi. The mixture was homogenized at 500 rpm for 15 minutes, thus forming a first coating layer on the fermented kimchi.

Alternatively, dextrin and starch, as the freezing stabilizers, may also be added before the fermentation process.

The fermented kimchi, subjected to the first-step coating, was rapidly frozen to −40° C., and then dried at 35° C. in a vacuum of 2 mmHg. Then, a 0.4 wt % solution of casein protein was added in the dried fermented kimchi in a fluidized bed granulator in an amount of 0.6 wt % based on the weight of the dried kimchi, thus forming a second coating layer of the casein protein on the fermented kimchi. Then, a 0.5 wt % solution of sea tangle powder in a purified solution was added to the dried fermented kimchi in the fluidized bed granulator in an amount of 0.3 wt % based on the weight of the dried fermented kimchi, thus forming a third coating layer on the dried fermented kimchi.

After completion of the coating process, the powder was sieved through an oscillator equipped with a 30 mesh screen so as to have a uniform particle size, thereby preparing triple-coated kimchi powder containing living kimchi lactic acid bacteria.

In Comparative Example, the preparation of kimchi powder was carried out in the same manner as in Example 1, except that the freezing stabilizers, dextrin and starch, were not added.

### Example 2

The crushed kimchi prepared according to the method described in Example 1 was fermented using selected kimchi lactic acid bacteria strain Lactobacillus sakei JYH2005 (strain isolated and identified by the present inventors; containing about 5×10⁶ CFU/g of kimchi lactic acid bacteria) as a kimchi fermentation starter.

The lactic acid bacteria stain Lactobacillus sakei JYH2005 was added to the crushed kimchi, and a mixture of soybean milk and skimmed milk powder (1:2 w/w) as freezing stabilizers was added to the crushed kimchi in an amount of 8 wt % based on the weight of the crushed kimehi. Then, the mixture was stirred for 20 minutes and fermented at 12° C. for 5 days, and then at 18° C. for 2 days. Then, each of 1.3 wt % of gellan gum, sodium casein and sea tangle powder was added to the fermented kimchi and subjected to first-step coating, freeze drying, second-step coating, third-step coating and screening, as described in Example 1, thereby preparing kimchi powder containing living kimchi lactic acid bacteria. Herein, the freezing stabilizers, soybean milk and skimmed milk powder, may also be added after the fermentation process.

A bacterial strain, isolated and identified from the resulting kimchi powder containing kimchi lactic acid bacteria, was Lactobacillus sakei, which formed 100% of the isolated strain.

### Example 3

Lactic acid bacteria-fermented sweet potato was added to a raw material of crushed kimchi. For the growth promotion and freeze-drying stability of lactic acid bacteria, a 2 wt % solution of sodium glutamate and gelatin (1:1 w/w) was added to the mixture, and then the resulting mixture was subjected to lactic acid fermentation. Then, the fermented kimchi was powdered through the freeze drying, coating and screening processes as described in Example 1.

### Example 4

0.01-50 wt % of commercially available, living lactic acid bacteria-containing powder (lactic acid bacteria count: about 3×10⁹ CFU/g) was added to 50-99.9 wt % of either the kimchi powder prepared in Example 1 or a kimchi powder composition (e.g., dried granular kimchi, dried kimchi block or dried kimchi) prepared using the kimchi powder, thus preparing a kimchi lactic acid bacteria-containing kimchi composition having a size of 10-180 mesh.

Herein, as the kimchi powder or the kimchi powder composition prepared using the same, commercially available dried kimchi powder containing little or no living lactic acid bacteria may also be used. Also, the blend of the kimchi powder or kimchi powder composition with the lactic acid bacteria-containing powder preferably contains more than 1×10⁵ CFU/g of lactic acid bacteria.

### Example 5

10 wt % of milk powder was suspended in 90 wt % of purified water, and the suspension was sterilized in a high-temperature and high-pressure sterilizer, and then inoculated with about 5×10⁶ CFU/g of Lactohacillus plantarum KLSC3067 (deposited with the Department of Biological Sciences, Inha University, Korea, in January, 2005). Next, the solution was cultured at 37° C. for 48 hours, and then powdered by freeze-drying it and subjecting the dried material to the three-step coating process as described in Example 1, thus preparing powder containing more than 3×10⁹CFU/g of lactic acid bacteria.

### Example 6

80 wt % of commercially available soybean paste (doenjang) powder, prepared through hot-air drying, was mixed with 10 wt % of the kimchi lactic acid bacteria-containing kimchi powder, prepared in Example 2, and 5 wt % of commercially available lactic acid bacteria powder, thus preparing lactic acid bacteria-containing soybean paste powder having a size of 10-180 mesh. The prepared paste powder was a composition containing 1×10⁴ to 1×10¹⁰ CFU/g, and could be ingested after adding only water thereto and stirring the solution.

### Example 7

Kimchi lactic acid bacteria-containing kimchi powder was prepared in the same manner as in Example 1, except that 4 wt % of cheese or glycerol was used instead of dextrin and starch as the freezing stabilizers.

### Examples 8 to 19

For the freeze stability of lactic acid bacteria in crushed non-fermented kimchi, each of NaHCO₃ (Example 8), KHCO₃ (Example 9), CaCO₃ (Example 10), sodium glutamate (Example 11), gelatin and glycerol (1:1) (Example 12), adonitol (Example 13), sugar alcohol (Example 14), milk (Example 15), dextrin (Example 16), starch (Example 17), cheese (Example 18) and soybean milk (Example 19) was added to the crushed non-fermented kimchi. Then, each of the mixtures was fermented, and gellan gum, casein protein and sea tangle powder were sequentially added thereto. Then, each of the mixtures was subjected to a freeze drying process, thereby preparing the kimchi powder products of Examples 8 to 19.

### Examples 20 to 31

For the freeze stability of crushed fermented kimchi, each of NaHCO₃ (Example 20), KHCO₃ (Example 21), CaCO₃ (Example 22), sodium glutamate (Example 23), gelatin and glycerol (1:1) (Example 24), adonitol (Example 25), sugar alcohol (Example 26), milk (Example 27), dextrin (Example 28), starch (Example 29), cheese (Example 30) and soybean milk (Example 31) was added to the crushed fermented kimchi. Then, gellan gum, casein protein and sea tangle powder were sequentially added thereto, and each of the mixtures was subjected to a freeze drying process, thereby preparing kimchi powder products of Examples 20 to 31.

### Example 32

Materials for preparing a coated kimchi product were provided to have the following composition ratio: based on 100 wt % of the coated kimchi product, 80.37 wt % of fermented kimchi, 0.11 wt % of gellan gum, 0.53 wt % of sea tangle powder, 11.39 wt % of milk powder, 3.8 wt % of dextrin, and 3.8 wt % of sodium casein.

80.37 wt % of fermented kimchi was passed through a chopper, equipped with a 7.5-HP motor and a disc plate having 1-12 mm holes, thus making crushed kimchi. To the crushed kimchi, 1.9 wt % of dextrin and 5.695 wt % of milk powder were added, and the mixture was fermented at 37° C. for 5 hours. Then, 1.9 wt % of dextrin, 5.695 wt % of milk powder, 0.11 wt % of gellan gum, 3.8 wt % of sodium casein and 0.53 wt % of sea tangle powder were added thereto, and the mixture was stirred at a speed of 50 rpm to coat the fermented kimchi with the additives, and was then subjected to a freeze drying process. Specifically, the coated fermented kimchi was frozen at −30° C., and then dried at 30° C. for 1-5 days. The dried kimchi was passed through a pulverizer, a sieve or an oscillator, which were equipped with a 20 mesh screen, thus preparing a coated kimchi product.

### Example 33

A coated kimchi product was prepared in the same manner as in Example 8, except that 1.9 wt % of dextrin and 5.695 wt % of milk powder were added to crushed kimchi, and the mixture was sterilized in a high-temperature and high-pressure sterilizer at a temperature of 120° C. and a pressure of 1.2 kg/cm² for 30 minutes, and was then maintained at 37° C. for 12 hours.

### Examples 34 to 42

Kimchi powder products were prepared in the same manner as in Example 3, except that each of lactic acid bacteria-fermented potato (Example 34), lactic acid bacteria-fermented yam (Example 35), lactic acid bacteria-fermented chlorella (Example 36), lactic acid bacteria-fermented spirulina (Example 37), lactic acid bacteria-fermented dietary fiber (Example 38), lactic acid bacteria-fermented carbohydrates (Example 39), lactic acid bacteria-fermented guar gum (Example 40), lactic acid bacteria-fermented milk-containing casein protein (Example 41) and lactic acid bacteria-fermented ginseng (Example 42) was added to crushed kimchi.

### Examples 43 to 46

Paste powder products were prepared in the same manner as in Example 6, except that 10 wt % of the kimchi lactic acid bacteria-containing kimchi powder prepared in Example 2 and 5 wt % of commercially available lactic acid bacteria powder were added to 85 wt % of each of commercially available dried red pepper paste (gochujang) powder (Example 43), Chinese bean paste (chunjang) powder (Example 44), vinegar red pepper paste (chogochujang) powder (Example 45) and fermented soybean paste (chungkukjang) powder.

### Test Example

The kimchi powder products, prepared in the above Examples, were divided into those to which the freezing stabilizer was not added, and those to which the freezing stabilizer was added. Then, the number of lactic acid bacteria in each of the kimchi powder products was measured immediately after the kimchi powder products were prepared. The measurement results are shown in Table 1 below.

The number of the isolated lactic acid bacteria was determined by plating the lactic acid bacteria on an MRS plate medium, culturing the bacteria at 37° C. for 24 hours, and then comparatively assessing the resulting colonies.

TABLE 1

| | Lactic acid bacteria/g: immediately |
|---|---|
| Kind of freezer stabilizer | after preparation process |
| No freezing stabilizer was added | 3.2 × 10⁵ |
| (Comparative Example) | |
| Dextrin and starch (Example 1) | 4.5 × 10¹⁰ |
| Soybean milk and milk powder | 7.8 × 10¹⁰ |
| (Example 2) | |
| Cheese ((Example 7) | 3.6 × 10¹⁰ |
| Glycerol ((Example 7) | 7.1 × 10⁹ |

* Fermented Kimchi: 9 × 10¹⁰ as calculated in terms of weight excluding water content.

As can be seen in Table 1 above, the stability of lactic acid bacteria in the kimchi powder of the present invention, to which the freezing stabilizer was added, was very good.

1. A method for preparing kimchi powder, comprising the steps of:
adding one or more selected from the group consisting of skimmed milk powder, skimmed milk, starch, dextrin, soybean milk, cheese and glycerol, to crushed or chopped kimchi, produced by grinding or crushing kimchi, before or after a fermentation process; and
freeze-drying the mixture so as to powder it.

2. A method for preparing kimchi powder, comprising the steps of:
adding one or more selected from the group consisting of skimmed milk powder, skimmed milk, starch, dextrin, soybean milk, cheese and glycerol, to ground or crushed kimchi produced by grinding or crushing kimchi, before or after a fermentation process;
adding, to the mixture, either sterilized and fermented kimchi or an isolated and identified lactic acid bacteria strain as a fermentation starter, followed by fermentation; and
freeze-drying the fermented product so as to powder it.

3. A method for preparing kimchi powder, comprising the steps of:
adding one or more selected from the group consisting of NaHCO₃, KHCO₃, CaCO₃, sodium glutamate, gelatin, glycerol, adonitol, sugar alcohol, a milk product or a processed milk product, dextrin, starch, and cereal flour, to one or more selected from one or more of carbohydrate-containing foods obtained by lactic acid bacteria fermentation, crushed kimchi, functional kimchi, kimchi and fermented kimchi;
fermenting the mixture with lactic acid bacteria, if necessary; and
subjecting the mixture to a freeze-drying process and a low-temperature drying process at 0-60° C. so as to powder it.

4. The method of claim 3, wherein the carbohydrate-containing food is any one selected from among crushed edible plants or extracts, crushed cereals or extracts, crushed fruit vegetables or extracts, crushed seaweed or extracts, crushed fruit, crushed vegetables, soybeans or processed soybean products, sweet potatoes or processed sweet potato products, potatoes or processed potato products, yams or processed yam products, chlorophyll-containing foods, processed embryos, chlorella, spirulina, yeast, enzymes, red pepper paste (gochujang), fermented soybean paste (chungkukjang), soybean paste (doenjang), pickles, mushrooms, dietary fibers, carbohydrates, guar gum, gellan gum, milk-containing casein proteins, milk proteins, ginseng, teas and fermented vegetables.

5. The method of claim 3, wherein the milk product or the processed milk product is any one selected from among milk, a processed milk product derived from milk, lactose, milk protein, an artificial milk powder composition, an artificial milk composition, a milk product composition, a milk product derived from livestock, cheese, skimmed milk, skimmed milk powder, whole milk powder, condensed milk and soybean milk.

6. The method of claim 3, wherein the cereal flour is any one selected from among rice flour, wheat flour, buckwheat flour, barley flour, Indian millet flour, Italian millet flour, millet flour, and maize flour.

7. A kimchi powder composition, comprising:
kimchi powder prepared according to the method of any one of claims 1 to 3; and
soybean paste powder and lactic acid bacteria powder, the composition containing 1×10³ to 1×10¹¹ CFU/g of lactic acid bacteria.

8. The kimchi powder composition of claim 7, wherein the soybean paste powder is any one selected from among Gochujang powder, soybean paste powder, Chinese bean paste (chunjang) powder, vinegar red pepper paste (chogochujang) powder, Chungkukjang powder, a ssamjang (soybean paste/Gochujang mixture) powder, makjang (fermented soybeans, flied soybean powder, salt, and redhot pepper powder) powder, jipjang (bean paste made from dried soybean malt, red pepper powder, glutinous rice, and dried slices of radish or cucumber) powder, and mixtures thereof.

9. The kimchi powder composition of claim 7, which has a particle size of 10-180 mesh.

10. A method for preparing kimchi powder, comprising the steps of:
adding one or more selected from the group consisting of NaHCO₃, KHCO₃, CaCO₃, sodium glutamate, gelatin, glycerol, adonitol, sugar alcohol, a milk product or a processed milk product, dextrin, starch and cereal flour, to ground or crushed kimchi produced by grinding or crushing non-fermented or fermented kimchi;
fermenting the mixture, if necessary, and then adding and mixing with the mixture one or more selected from the group consisting of gellan gum, casein protein and sea tangle powder; and
freeze-drying the mixture.

11. The method of claim 10, wherein the milk product or the processed milk product is any one selected from among milk, a processed milk product derived from milk, lactose, milk protein, an artificial milk powder composition, an artificial milk composition, a milk product composition, a milk product derived from livestock, cheese, skimmed milk, skimmed milk powder, whole milk powder, condensed milk and soybean milk.

12. The method of claim 10, wherein the cereal powder is any one selected from among rice flour, wheat flour, buckwheat flour, barley flour, Indian millet flour, Italian millet flour, millet flour, and maize flour.

13. A method for preparing kimchi powder, comprising the steps of:
crushing 55-96.5 wt % of fermented kimchi to produce crushed kimchi;
adding, to the crushed kimchi, 0.5-5 wt % of dextrin and 1-10 wt % of milk powder;
maintaining the resulting kimchi at 5-40° C. for 3-24 hours to ferment it;
adding, to the fermented kimchi, 0.5-5 wt % of dextrin, 1-35 wt % of milk powder, 0.05-3 wt % of gellan gum, 0.1-7 wt % of sodium caseinate and 0.1-5 wt % of sea tangle powder, and stirring the mixture so as to coat the fermented product with the additives; and
freezing the coated fermented product at −20° C. to −60° C., followed by drying at 5-40° C. for 1-5 days.

14. The method of claim 13, further comprising, after the step of adding 0.5-5 wt % of dextrin and 1-10 wt % of milk powder to the crushed kimchi,
a step of sterilizing the mixture at 60-130° C. for 10-60 minutes at a pressure of 0.1-5 kg/cm² or sterilizing the mixture with a radiation dose of 0.5-5 kGy; and
adding isolated and identified lactic acid bacteria to the sterilized mixture.

15. A kimchi powder composition, comprising:
either kimchi powder prepared according to any one of claims 1 to 6 and 10 to 14, or a kimchi composition containing said kimchi powder;
living lactic acid bacteria-containing powder, the kimchi powder composition containing more than 1×10⁵ CFU/g of lactic acid bacteria.

16. The kimchi powder composition of claim 15, wherein the content of the kimchi powder or kimchi composition in the kimchi powder composition is 50-99.9 wt %, and the content of the living lactic acid bacteria-containing powder in the kimchi powder composition is 0.01-50 wt %.

17. The kimchi powder composition of claim 15, which has a particle size of 10-180 mesh.
